(19) United States
(12) Patent Application Publication
(10) Pub. No.: US 2022/0197279 A1
(43) Pub. Date: Jun. 23, 2022

(54) IMAGE PROCESSING SYSTEM, IMAGE PROCESSING METHOD, AND IMAGE PROCESSING DEVICE USING UNMANNED MOBILE BODY

(71) Applicant: Spicy Drone Kitchen Corporation, Tokyo (JP)

(72) Inventor: Takafumi MATSUDOME, Kanagawa (JP)

(21) Appl. No.: 17/612,249

(22) PCT Filed: Feb. 21, 2020
(86) PCT No.: PCT/JP2020/007260

§ 371 Date: Nov. 18, 2021

(30) Foreign Application Priority Data
May 21, 2019 (JP) 2019-095492
Oct. 30, 2019 (JP) 2019-197746

(51) Int. Cl. G05D 1/00; G06V 20/56; B64C 39/02; B64D 47/08

(52) U.S. Cl. CPC G05D 1/0038; G06V 20/56; B64C 2201/127; B64D 47/08; B64C 2201/027; B64C 39/024

(57) ABSTRACT

An image processing system capable of detecting the position of an unmanned mobile body and measuring the timing of passing a predetermined position is provided. The system includes an unmanned mobile body in which an imaging apparatus is mounted and an image processing device that is connected to the unmanned mobile body by wireless communication and displays an image captured by the imaging apparatus. The image processing device includes: an image data acquisition unit acquiring image data; a screen display unit displaying the image on a display; a mark detection unit detecting the presence of a detection mark in the image; and a gate passing determination unit determining that the unmanned mobile body has passed through a passing gate in which the detection mark is provided when the detection mark is detected under predetermined condition. The screen display unit displays the image and the content based on the determination result.

### TECHNICAL FIELD

The present invention relates to an image processing system, an image processing method, and an image processing device using an unmanned mobile body and in particular, to an image processing system, an image processing method, and an image processing device using an unmanned mobile body in which an imaging apparatus is mounted and which moves while capturing an external image.

### BACKGROUND ART

In recent years, with the spread of lithium-ion batteries and the miniaturization and price reduction of electronic devices such as micro electro mechanical systems (MEMS), gyroscopes, and acceleration sensors, unmanned aerial vehicles (drones) with low noise, high stability, and easy remote control are now available on the market at low prices, and the drone business is entering the market one after another.

As a businesses using drones, various uses, such as aerial imaging for image content, aerial photogrammetry, investigation of disaster situation, search for missing persons, and infrastructure inspection in urban areas, can be mentioned.

For example, in the information distribution system using a drone described in Patent Literature 1, it is disclosed to operate a drone equipped with an imaging apparatus and image a player while moving the player to a position where imaging is possible so that the player's image is delivered in real time when there is a request for the player's image. In addition, it is disclosed to collect information (for example, heart rate, blood pressure, and tension) of a player selected as a player of interest and deliver the player's image in real time when the information of the player is in a predetermined state.

In addition, recently, races to compete for drone operation skills have been held in various places of Japan and overseas, and have been drawing attention as a new motor sport.

In the drone race, an operator wears a head-mounted display and can perform remote control while watching a real-time image transmitted from an imaging apparatus mounted on the front side of the drone, and spectators can watch the real-time image on a large display.

In holding the drone race, if the total weight of the drone is less than 200 g and the drone is flown indoors, the drone race is not subject to regulations based on the Aviation Law. For this reason, in the case of a relatively small drone race, the legal and regulatory hurdles are low and accordingly, this has been drawing attention as a familiar entertainment.

### CITATION LIST

### Patent Literature

PATENT LITERATURE 1: JP 2018-61106 A
PATENT LITERATURE 2: JP 2002-369976 A

### SUMMARY OF INVENTION

### Technical Problem

Incidentally, in managing the drone race, in order to enhance entertainment in a place where operators and viewers can watch real-time images transmitted from the imaging apparatus mounted in the drone, a realistic production effect is required. More specifically, in a conventional drone race, a measuring device for measuring the radio wave strength is usually used to measure the lap times of a plurality of drones. Specifically, each drone is equipped with an antenna and is set to emit a unique radio wave assigned in advance. Then, the measuring device measures the radio wave strength of the radio wave received by the loop antenna provided at the goal point to determine which drone has lapped, and also measures the lap time of each drone (for example, there is a lap time measuring system for a radio-controlled mobile body described in Patent Literature 2).

However, in managing the race, it takes a relatively long time to install the measuring device or calibrate the measuring device. In addition, when the race venue is a relatively small indoor space, radio wave interference occurs. Accordingly, there has been a problem that the lap time cannot be accurately measured. In addition, even if the measuring device is used, the measuring point is at most one point for measuring the time at the goal in many cases.

In addition, when the drone passes through a plurality of passing gates while flying, it has been difficult to determine whether or not the drone has passed through the passing gates.

For this reason, in managing the drone race, there has been a demand for a technique capable of displaying the lap time, the current position, and the like of the drone in real time by measuring the lap time without being affected by radio wave interference and determining whether or not the drone has passed through the passing gate.

In addition, in managing the drone race, in order to enhance entertainment in a place where viewers can watch real-time images, which are transmitted from the imaging apparatus mounted in the drone, on a large display, there has been a demand for a realistic production effect on the display.

In addition, the present invention is not particularly limited to the production effect in the drone race, and there has also been a demand to apply an analysis technique, which is capable of accurately detecting the position of a flying drone using a passing gate installed at a predetermined position or capable of accurately measuring the timing of passing through the predetermined position, to businesses using drones.

The present invention has been made in view of the above problems, and it is an object of the present invention to provide an image processing system, an image processing method, and an image processing device using an unmanned mobile body that can accurately detect the position of an unmanned mobile body (drone) and accurately measure the timing of passing through a predetermined position.

In addition, it is another object of the present invention to provide an image processing system, an image processing method, and an image processing device using an unmanned mobile body that can create a realistic production effect in order to enhance entertainment in managing an unmanned mobile race (drone race).

### Solution to Problem

The aforementioned problems are solved as follows. An image processing system using an unmanned mobile body of the present invention is an image processing system using an unmanned mobile body including: an unmanned mobile body in which an imaging apparatus is mounted and which moves while capturing an external image; and an image processing device that is connected to the unmanned mobile body by wireless communication and processes an image captured by the imaging apparatus. The image processing device includes: an image data acquisition unit that acquires image data indicating an external image captured by the imaging apparatus; a screen display unit that displays the image indicated by the acquired image data on a display screen; a mark detection unit that detects presence of a detection mark as a detection target in the image indicated by the acquired image data; and a gate passing determination unit that determines that the unmanned mobile body has passed through a passing gate on which the detected detection mark is provided when the detection mark is detected under predetermined conditions in the image. The screen display unit displays, on the display screen, the image and a content based on a determination result when it is determined that the unmanned mobile body has passed through the passing gate.

With the above configuration, it is possible to realize an image processing system using an unmanned mobile body that can accurately detect the position of the unmanned mobile body and accurately measure the timing of passing the predetermined position by determining whether or not the unmanned mobile body has passed through the passing gate using the detection mark.

In addition, for example, in managing the unmanned mobile race, in order to further enhance entertainment, the content based on the determination result when it is determined that the unmanned mobile body has passed through the passing gate is displayed on the display screen, so that it is possible to realize an image processing system using an unmanned mobile body capable of creating a realistic production effect.

At this time, the unmanned mobile body may be a small unmanned aerial vehicle and move on a predetermined course in a predetermined space, and the image processing device may simultaneously display, on the display screen, images captured by the imaging apparatuses respectively mounted in a plurality of the unmanned mobile bodies.

With the above configuration, for example, in managing the race of small unmanned aerial vehicles (drones), in order to further enhance entertainment, it is possible to realize an image processing system capable of creating a realistic production effect.

At this time, the detection mark provided on the passing gate installed in a predetermined space may be further provided, and a plurality of the detection marks may be attached to the passing gate so as to surround a passing area in the passing gate.

As described above, by studying the arrangement of the plurality of detection marks, it is possible to further improve the accuracy in determining whether or not the unmanned mobile body has passed through the passing gate by using the detection marks.

In particular, when the passing gate has a loop shape (torus shape), a suitable detection mark arrangement pattern in determining whether or not the unmanned mobile body has passed through the frame of the passing gate is obtained.

At this time, the detection mark provided on the passing gate installed in a predetermined space may be further provided, and the detection mark may be a two-dimensional barcode and store identification data for identifying a corresponding passing gate among the plurality of passing gates installed in the predetermined space.

As described above, by adopting the two-dimensional barcode as a detection mark, it is possible to detect the detection mark relatively easily while suppressing the manufacturing cost.

In addition, since the identification data is stored in the detection mark, the current position of the unmanned mobile body can be detected more accurately.

At this time, after an area smaller than a passing area in the passing gate in a central portion of the image is set as a non-detection target area, when the detection mark is detected in an area different from the non-detection target area in a predetermined image and the detection mark is no longer detected in an image after the predetermined image, the gate passing determination unit may determine that the unmanned mobile body has passed.

In addition, after setting four detection target areas divided into four quadrants with respect to the image, when the detection mark is detected in all detection target areas of a first detection target area as a first quadrant, a second detection target area as a second quadrant, a third detection target area as a third quadrant, and a fourth detection target area as a fourth quadrant in a predetermined image and the detection mark is no longer detected in an image after the predetermined image, the gate passing determination unit may determine that the unmanned mobile body has passed.

With the above configuration, it is possible to further improve the accuracy in determining whether or not the unmanned mobile body has passed through the passing gate by using the detection marks.

At this time, the image processing device may include an elapsed time calculation unit that calculates, from the determination result of the gate passing determination unit, an elapsed time required for the unmanned mobile body to pass through a predetermined passing gate from a predetermined start position, and the screen display unit may display, on the display screen, the image and a content relevant to the elapsed time calculated by the elapsed time calculation unit.

In addition, the image processing device may include a current position calculation unit that calculates, from the determination result of the gate passing determination unit, a current position of the unmanned mobile body in the predetermined space, and the screen display unit may display, on the display screen, the image and a content relevant to the current position calculated by the current position calculation unit.

With the above configuration, for example, in managing the unmanned mobile race, the lap time or the current position of the unmanned mobile body and the content based on determination relevant to the passing gate can be displayed in real time on the display after measuring the lap time without being affected by radio wave interference and determining whether or not the unmanned mobile body has passed through the passing gate. As a result, it is possible to provide a screen with a more realistic production effect on the display.

In addition, it is possible to realize an image processing method using an unmanned mobile body in which a computer connected to an unmanned mobile body, in which an imaging apparatus is mounted and which moves while capturing an external image, by wireless communication processes an image captured by the imaging apparatus. The image processing method causes the computer to execute: an image data acquisition step for acquiring image data indicating an external image captured by the imaging apparatus; a first screen display step for displaying the image indicated by the acquired image data on a display screen; a mark detection step for detecting presence of a detection mark as a detection target in the image indicated by the acquired image data; a gate passing determination step for determining that the unmanned mobile body has passed through a passing gate on which the detected detection mark is provided when the detection mark is detected under predetermined conditions in the image, and a second screen display step for displaying, on the display screen, the image and a content based on a determination result when it is determined that the unmanned mobile body has passed through the passing gate.

In addition, it is possible to realize an image processing device using an unmanned mobile body that is connected to the unmanned mobile body, in which an imaging apparatus is mounted and which moves while capturing an external image, by wireless communication and processes an image captured by the imaging apparatus, the device comprising: an image data acquisition unit that acquires image data indicating an external image captured by the imaging apparatus; a mark detection unit that detects presence of a detection mark as a detection target in the image indicated by the acquired image data; and a gate passing determination unit that determines that the unmanned mobile body has passed through a passing gate on which the detected detection mark is provided when the detection mark is detected under predetermined conditions in the image.

### Advantageous Effects of Invention

According to the image processing system, the image processing method, and the image processing device using an unmanned mobile body of the present invention, it is possible to accurately detect the position of the unmanned mobile body and accurately measure the timing of passing through a predetermined position.

In addition, in order to enhance entertainment in managing the unmanned mobile race, it is possible to create a realistic production effect.

### BRIEF DESCRIPTION OF DRAWINGS

FIG. 1 is a configuration diagram of the entire image processing system of the present embodiment.

FIG. 2 is a configuration diagram of an unmanned mobile body, an operation terminal, and a head-mounted display.

FIG. 3 is a configuration diagram of an unmanned mobile body, an image processing device, and a display.

FIG. 4A is a diagram showing a passing gate with a detection mark.

FIG. 4B is a diagram showing a modification example of a passing gate with a detection mark.

FIG. 5 is a hardware configuration diagram of an image processing device.

FIG. 6 is a software configuration diagram of an image processing device.

FIG. 7 is a diagram showing an example of a display screen displayed by a screen display unit.

FIG. 8 is a diagram illustrating an example of processing by a gate passing determination unit.

FIG. 9 is a process flow diagram showing an example of an image processing method of the present embodiment.

FIG. 10 is a diagram showing an example of a display screen displayed by a screen display unit.

FIG. 11 is a process flow diagram showing an example of a movement start determination method.

### DESCRIPTION OF EMBODIMENTS

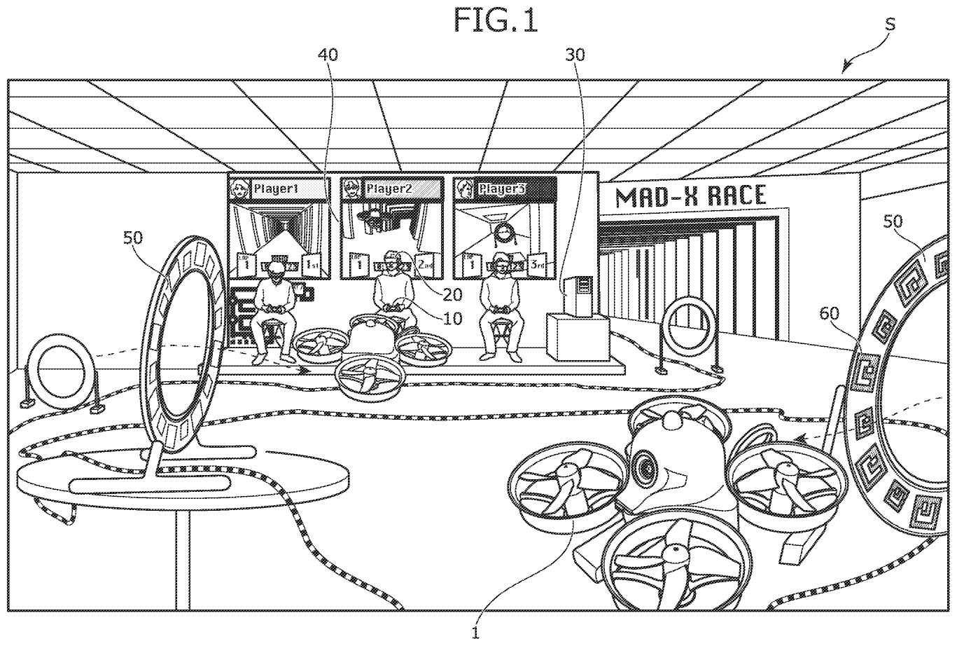

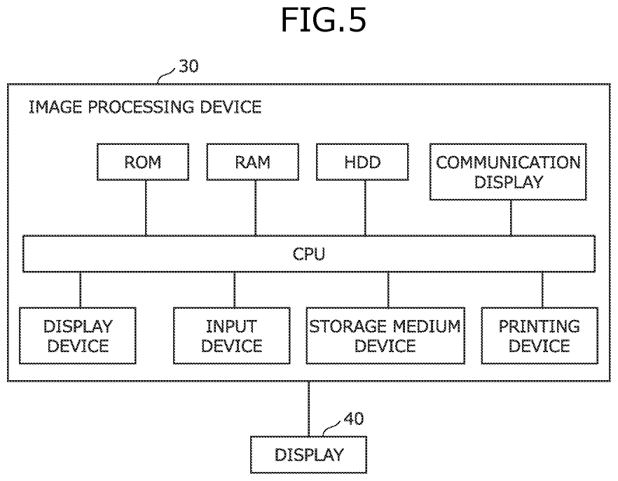

Hereinafter, an embodiment of the present invention will be described with reference to FIGS. 1 to 11.

The present embodiment relates to an image processing system including: a small unmanned mobile body in which an imaging apparatus is mounted and which flies while capturing an external image; and an image processing device that is connected to the unmanned mobile body by wireless communication and displays an image captured by the imaging apparatus. The image processing device includes: an image data acquisition unit that acquires image data indicating an external image captured by the imaging apparatus; a screen display unit that displays the image indicated by the acquired image data on a display; a mark detection unit that detects presence of a detection mark in the image indicated by the acquired image data; and a gate passing determination unit that determines that the unmanned mobile body has passed through a passing gate in which the detected detection mark is provided when the detection mark is detected under predetermined conditions in the image. The screen display unit displays, on the display, the image and a content based on a determination result when it is determined that the unmanned mobile body has passed through the passing gate.

FIG. 1 shows the overall configuration of an image processing system S of the present embodiment.

The image processing system S is a system for managing an unmanned mobile race, and is configured to mainly include: an unmanned mobile body 1 in which an imaging apparatus 1a is mounted and which flies while capturing an external image; an operation terminal 10 that is connected to the unmanned mobile body 1 by wireless communication to remotely control the unmanned mobile body 1; a head-mounted display 20 that displays an external image captured by the imaging apparatus 1a; an image processing device 30 that processes the external image captured by the imaging apparatus 1a and displays the processed external image on a display screen; a display 40 for a display screen that is connected to the image processing device 30; a plurality of passing gates 50 installed at intervals in a predetermined space; and a detection mark 60 attached to each passing gate 50.

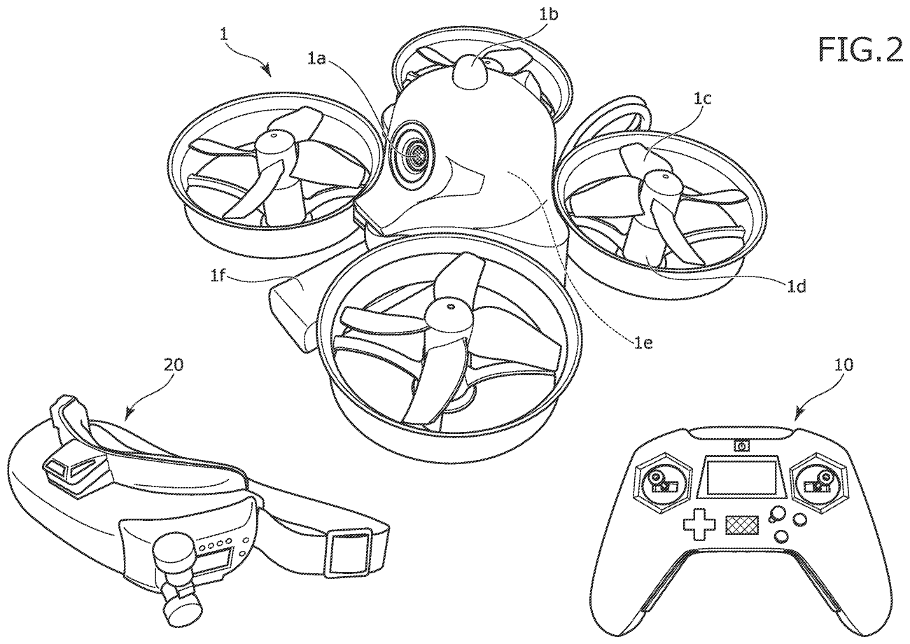

As shown in FIGS. 1 and 2, the unmanned mobile body 1 is a small unmanned aerial vehicle (drone) that flies in a predetermined space while capturing an external image on the front side thereof, and performs data communication with the operation terminal 10, the head-mounted display 20, and the image processing device 30.

A plurality of unmanned mobile bodies 1 are prepared. In the system of the present embodiment, three unmanned mobile bodies 1 participate in the unmanned mobile race and fly on a predetermined course in a predetermined space (due to the radio wave band of 5.8 GHz, it is normal for three aircraft to fly at the same time).

Specifically, the unmanned mobile body 1 is configured to mainly include the imaging apparatus 1a, a transmission and reception antenna 1b, a moving unit 1c, a driving unit 1d, a processor 1e, and a battery 1f, and each of these is attached to the main body of the unmanned mobile body 1.

The imaging apparatus 1a is a small imaging camera, is attached to the front surface of the main body of the mobile body, and captures an external image on the front side thereof and records the image. Then, image data showing the image is generated.

The transmission and reception antenna 1b is mounted inside the main body of the mobile body, and receives operation data from the operation terminal 10 or transmits the captured image data to the head-mounted display 20 and the image processing device 30.

The moving unit 1c is four rotary blades attached so as to surround the main body of the mobile body, and is configured by attaching propeller-shaped blades to a rotating shaft extending vertically, and receives drive power from the driving unit 1d and rotates to generate lift and thrust.

The driving unit 1d is a motor for driving the moving unit 1c, and is connected and attached to the moving unit 1c and operates based on a drive command received from the processor 1e.

The processor 1e is a microprocessor configured to mainly include a CPU as a data calculation and control processing device, a ROM, a RAM, and an HDD as storage devices, a communication interface for transmitting and receiving information data through the transmission and reception antenna 1b, and is mounted inside the main body of the mobile body.

The battery 1f is a lithium-ion battery for supplying electric power to the transmission and reception antenna 1b, the driving unit 1d, and the processor 1e, and is attached to the lower part of the main body of the mobile body.

As shown in FIGS. 1 and 2, the operation terminal 10 is a controller operated by the operator, and is provided for each unmanned mobile body 1 and remotely controls the unmanned mobile body 1 by wireless communication so that the unmanned mobile body 1 flies on a predetermined course.

More specifically, the operation terminal 10 can receive the input of a user operation by the operator, generate operation data for operating the unmanned mobile body 1, and transmit the operation data to the unmanned mobile body 1.

The head-mounted display 20 is a display device mounted on the operator's head, and is provided for each unmanned mobile body 1 to display an image captured by the imaging apparatus 1a on a dedicated display screen.

More specifically, the head-mounted display 20 can receive image data in real time from the unmanned mobile body 1 and display the real-time image on the dedicated display screen.

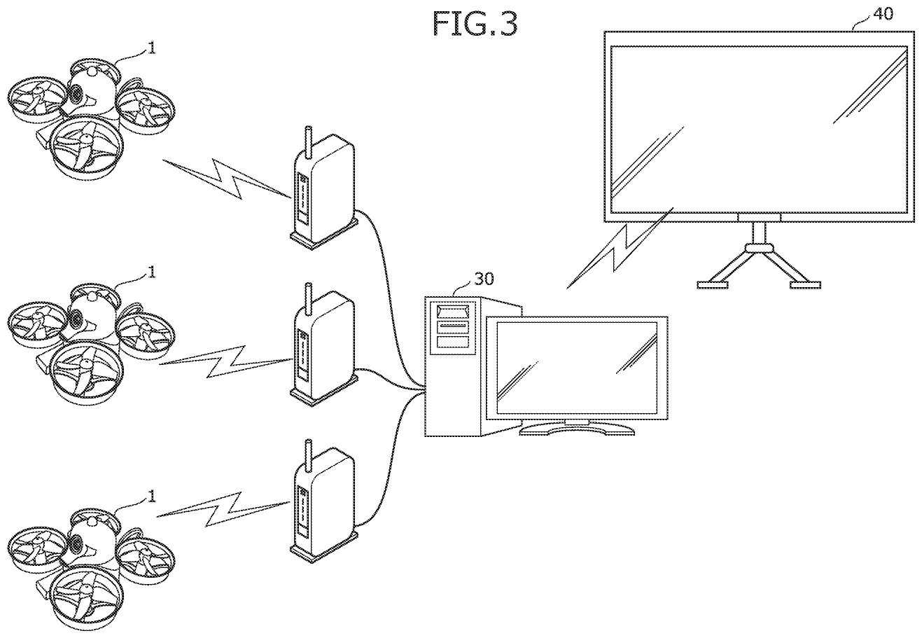

As shown in FIGS. 1 and 3, the image processing device 30 is a computer that performs data communication with the unmanned mobile body 1 and the display 40, and displays the image captured by the imaging apparatus 1a on the display 40 as a display screen.

More specifically, when the detection mark 60 is detected under predetermined conditions in the image, the image processing device 30 can determine that the detection mark 60 has passed through the passing gate 50 to which the detection mark 60 is attached, and the image and the content based on the determination result of the determination that the unmanned mobile body 1 has passed through the passing gate 50 can be simultaneously displayed on the display 40.

The display 40 is a large display connected to the image processing device 30, and is used as a display screen for spectators watching the unmanned mobile race.

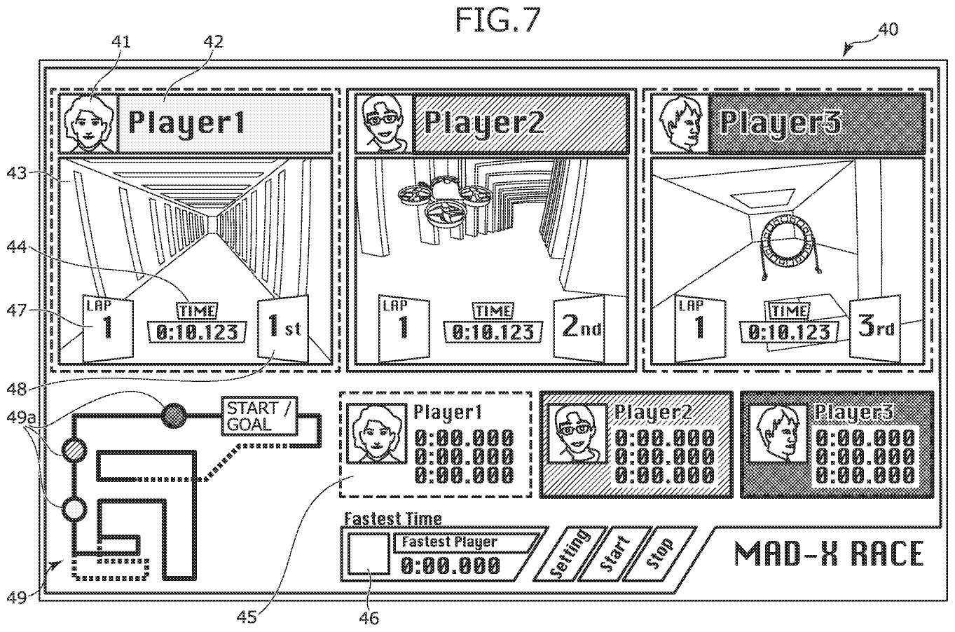

Specifically, a display screen shown in FIG. 7 is displayed in real time on the display 40, so that it is possible to produce the realistic content of the unmanned mobile race.

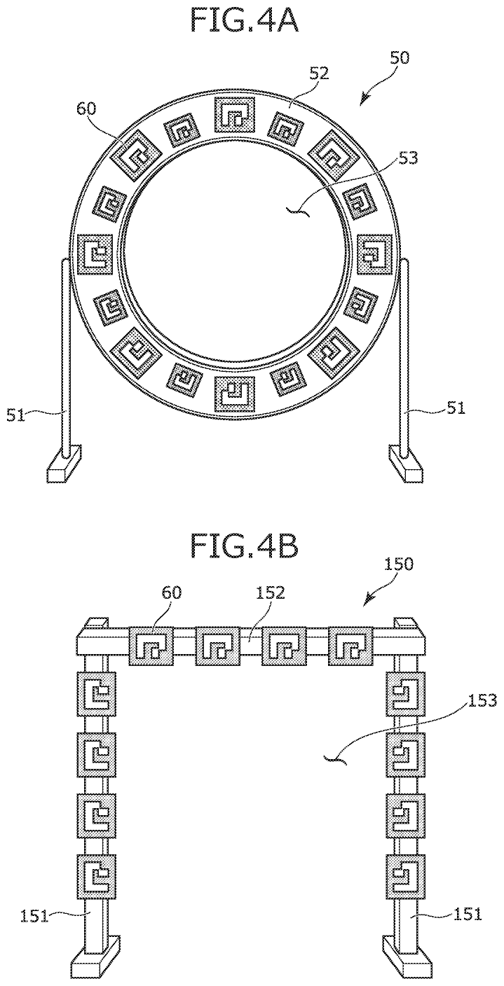

As shown in FIGS. 1 and 4A, the passing gate 50 is a gate for the unmanned mobile body 1 to pass through, and a plurality of passing gates 50 are installed at predetermined intervals on the course of an unmanned mobile race installed in a predetermined space.

The passing gate 50 is configured to include a pair of gate legs 51 provided so as to stand up from the floor and a loop-shaped gate frame body 52 attached so as to connect upper portions of the pair of gate legs 51 to each other.

In the unmanned mobile race, the unmanned mobile body 1 operated by the operator flies so as to pass through a passing area 53 provided in the frame of the gate frame body 52.

A plurality of detection marks 60 are attached to the front surface of the gate frame body 52, which is located on the start side in the traveling direction of the course, so as to surround the passing area 53.

The detection marks 60 are two-dimensional barcodes and are arranged in an approximately circular shape so as to surround the passing area 53 of the passing gate 50, and the detection marks 60 having different sizes are alternately arranged.

In addition, the detection mark 60 is formed of white as a background color and black as a barcode color, and is configured so that the shape of the barcode is an approximately C shape. In addition, each of the detection marks 60 is arranged so that the opening portion (approximately C-shaped opening portion) of the barcode faces the center of the passing area 53.

The detection mark 60 stores identification data for identifying the corresponding passing gate 50 among the plurality of passing gates 50 installed on the course.

Therefore, when the detection mark 60 is detected in the image captured by the unmanned mobile body 1 (imaging apparatus 1a), the image processing device 30 can specify which passing gate 50 the unmanned mobile body 1 has passed through.

In addition, the passing gate 50 can be changed without being particularly limited to a loop-shaped (torus-shaped) passing gate, and may be, for example, a bridge-shaped passing gate 150 as shown in FIG. 4B.

The passing gate 150 is configured to include a pair of gate legs 151 and a gate frame body 152 for connecting upper portions of the pair of gate legs 151 to each other, and the area surrounded by the pair of gate legs 151 and the gate frame body 152 is a passing area 153.

In addition, the detection marks 60 are arranged in an approximately C shape so as to surround the passing area 153 of the passing gate 150.

<Hardware Configuration of Image Processing Device 30>

The image processing device 30 is a computer including a CPU as a data calculation and control processing device, a ROM, a RAM, and an HDD (SSD) as storage devices, and a communication interface for transmitting and receiving information data through a home network or the Internet.

In addition, the image processing device 30 further includes a display device for displaying information of characters or images displayed in a predetermined format, an input device operated by the user when inputting a predetermined command to the CPU, a storage medium device such as an external hard disk, and a printing device for outputting text or image information, and is connected to the display 40.

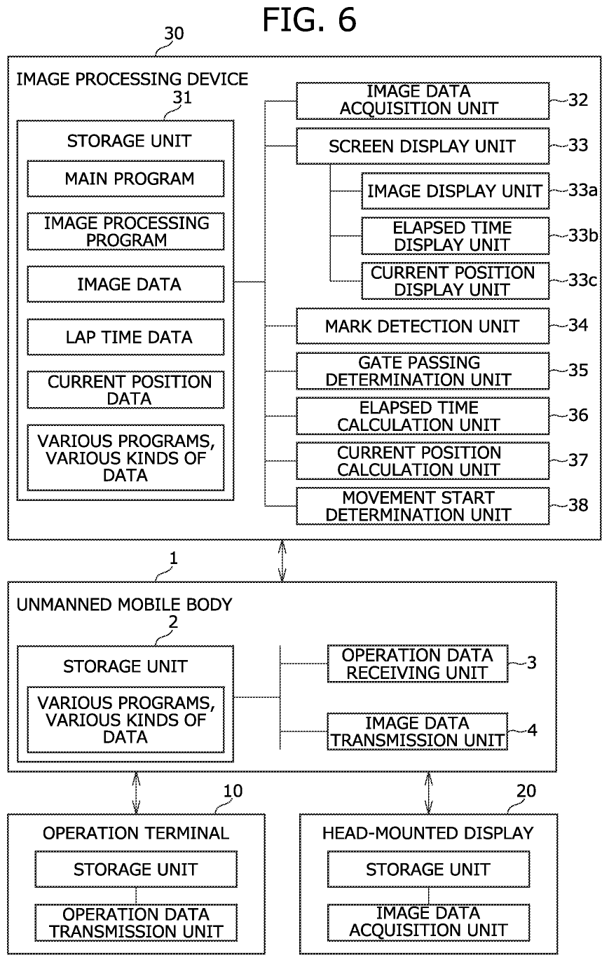

As shown in FIG. 6, an image processing program is stored in the ROM, HDD, and external storage device of the image processing device 30 in addition to a main program that functions as a computer, and these programs are executed by the CPU to realize the functions of the image processing device 30.

<Software Configuration of Image Processing Device 30>

As shown in FIG. 6, from the functional point of view, the image processing device 30 includes, as main components, a storage unit 31 that stores various programs and various kinds of data in addition to “image data”, “lap time data”, and “current position data”, an image data acquisition unit 32 that acquires “image data” from the unmanned mobile body 1, a screen display unit 33 that displays an image indicated by the acquired “image data” on the display screen, a mark detection unit 34 that detects the presence of the detection mark 60 in the image shown by the acquired “image data”, and a gate passing determination unit 35 that determines that, when the detection mark 60 is detected under predetermined conditions in a predetermined image, the unmanned mobile body 1 has passed through the passing gate 50 in which the detected detection mark 60 is provided.

In addition, the image processing device 30 further includes an elapsed time calculation unit 36 that calculates an elapsed time, which is required for the unmanned mobile body 1 to pass through a predetermined passing gate 50 from a predetermined position, from the determination result of the gate passing determination unit 35 and a current position calculation unit 37 that calculates the current position of the unmanned mobile body 1 in a predetermined space from the determination result of the gate passing determination unit 35.

In addition, the image processing device 30 further includes a movement start determination unit 38 that determines that the unmanned mobile body 1 has started moving when predetermined conditions are satisfied based on the “image data” acquired from the unmanned mobile body 1 at the timing immediately before the unmanned mobile body 1 starts moving.

These are configured by a CPU, a ROM, a RAM, an HDD, a communication interface, various programs, and the like.

In addition, from the functional point of view, the unmanned mobile body 1 includes, as main components, a storage unit 2 that stores various programs and various kinds of data, an operation data receiving unit 3 that acquires “operation data” from the operation terminal 10, and an image data transmission unit 4 that transmits “image data” to the head-mounted display 20 and the image processing device 30.

The “image data” stored in the storage unit 31 is moving image data showing an external image on the front side of each unmanned mobile body 1 that is captured by each unmanned mobile body 1, and is transmitted in real time from each unmanned mobile body 1 during the unmanned mobile race and is centrally managed and stored in the storage unit 31.

In addition, in the image data (moving image data), for example, the number of frame images per second is set to 30 (30 FPS (Frame Per Second)).

By referring to the image data, as shown in FIG. 7, it is possible to use a function of simultaneously displaying images captured by the respective unmanned mobile bodies 1 on the display 40, a gate passing determination function of each unmanned mobile body 1, a lap time calculation function, and a current position calculation function.

The “lap time data” is data indicating the lap time of each unmanned mobile body 1 during the unmanned mobile race, and is generated for each unmanned mobile body 1 by the elapsed time calculation unit 36 and is centrally managed and stored in the storage unit 31.

More specifically, the lap time data includes not only the information of the elapsed time (section lap time) required for each unmanned mobile body 1 to pass through a predetermined passing gate 50 from a predetermined start position, the elapsed time required from the start position to one lap of the course (lap time of the first lap, second lap, third lap), or the elapsed time required from the start position to the goal position (total lap time required to finish three laps of the course) but also information of the elapsed time (section lap time) required from passing through the passing gate 50 on the start position side among the adjacent passing gates 50 to passing through the next passing gate 50.

In addition, not only the fastest lap time but also information of the current number of laps and current rankings during the unmanned mobile race is included.

By referring to the lap time data, as shown in FIG. 7, it is possible to use a function of displaying various lap times of the respective unmanned mobile bodies 1, the fastest lap time, the ranking of each unmanned mobile body 1, and the like on the display 40.

The “current position data” is data indicating the current position of each unmanned mobile body 1 on the course of the unmanned mobile race, and is generated for each unmanned mobile body 1 by the current position calculation unit 37 and is centrally managed and stored in the storage unit 31.

More specifically, the current position data includes position information indicating at which passing gate 50 each unmanned mobile body 1 is located on the course (indicating around which passing gate 50 each unmanned mobile body 1 is located).

By referring to the current position data, as shown in FIG. 7, it is possible to use a function of displaying the current position (current position on the course map) of each unmanned mobile body 1 on the display 40.

The image data acquisition unit 32 acquires “image data” from each unmanned mobile body 1, and the acquired image data is classified for each unmanned mobile body 1 and stored in the storage unit 31.

The screen display unit 33 has an image display unit 33a, an elapsed time display unit 33b, and a current position display unit 33c as specific functional units.

The screen display unit 33 (image display unit 33a) simultaneously displays, on the display 40, the images indicated by the “image data” acquired from the respective unmanned mobile bodies 1.

In addition, the screen display unit 33 displays, on the display 40, “content based on a determination result” when the gate passing determination unit 35 determines that each unmanned mobile body 1 has passed a predetermined passing gate 50.

More specifically, the elapsed time display unit 33b displays “content relevant to the elapsed time of each unmanned mobile body 1” calculated by the elapsed time calculation unit 36 on the display 40 in real time as the above-described content based on the determination result.

In addition, the current position display unit 33c can display “content relevant to the current position of each unmanned mobile body 1” calculated by the current position calculation unit 37 on the display 40 in real time as the above-described content based on the determination result.

In this example of FIG. 7 as a display screen on the display 40, an operator image 41 and an operator name 42 are displayed in the upper portion of the display screen as “information of the operator of each mobile body 1” (Player 1 to Player 3). In addition, a real-time image 43 captured in real time by each mobile body 1 is displayed corresponding to the operator's information, and the total race time 44 “0:10:123” of the unmanned mobile race is also displayed.

In addition, the lap time 45 of the first lap, second lap, and third lap of the course and the fastest lap time 46 are displayed in the lower right portion of the display screen as “content relevant to the elapsed time of each unmanned mobile body 1”, and the current number of laps 47 and the current ranking 48 are also displayed in the central portion of the display screen.

In addition, in the lower left portion of the display screen, a course map 49 of the unmanned mobile race and a current position display icon 49a of each unmanned mobile body 1 moving on the course map 49 in real time are displayed as “content relevant to the current position of each unmanned mobile body 1”.

In addition, a start button (Start) for starting an image processing program executed by the image processing device 30, a stop button (Stop), a setting button (Setting), and the like are displayed in the lower center portion of the display screen.

The mark detection unit 34 detects the presence of the detection mark 60 as a detection target in the image indicated by the acquired “image data”.

More specifically, since the number of frame images per second in the image data (moving image data) is set to 30 (30 FPS), the mark detection unit 34 detects that the detection mark 60 is present in the frame image for each of the frame images.

In addition, identification data for identifying the corresponding passing gate 50 among the plurality of passing gates 50 is stored in the detection mark 60. Therefore, when the mark detection unit 34 detects a predetermined detection mark 60 in a frame image captured by the predetermined unmanned mobile body 1, it is possible to specify at which passing gate 50 or around which passing gate 50 the unmanned mobile body 1 is located.

The gate passing determination unit 35 determines that the predetermined unmanned mobile body 1 has passed through the passing gate 50 in which the detected detection mark 60 is provided when the detection mark 60 is detected under predetermined conditions in an image indicated by the acquired “image data” and the detection mark 60 is no longer detected in an image after the image.

Specifically, when the detection mark 60 is detected in the first image under the following conditions and all the detection marks are not detected in the subsequent image, the gate passing determination unit 35 determines that the unmanned mobile body 1 has passed through the passing gate 50.

In addition, it may be determined that the unmanned mobile body 1 has passed when any one of the following conditions is satisfied, or it may be determined that the unmanned mobile body 1 has passed when other conditions are set and the other conditions are satisfied.

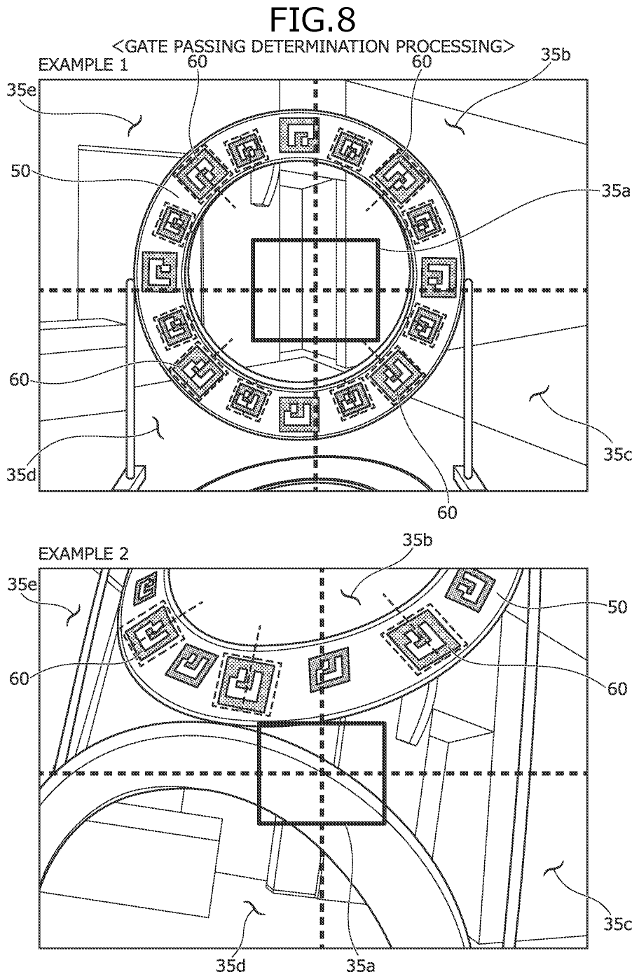

As the first condition, as shown in FIG. 8, the gate passing determination unit 35 sets a rectangular area having a predetermined size in a central portion of an image (frame image) in advance as a “non-detection target area 35a”. Then, when the detection mark 60 is detected in an area different from the “non-detection target area 35a” in a predetermined image (predetermined frame image), it is determined that the first condition is satisfied.

At this time, it is preferable that the non-detection target area 35a is an area smaller than the passing area in the predetermined passing gate 50. More specifically, it is preferable that the non-detection target area 35a is an area smaller than the smallest passing area among all the passing areas of the passing gates 50. In addition, the shape of the non-detection target area 35a is not limited to the rectangular shape, and may be, for example, a circular shape, and can be appropriately changed.

As the second condition, as shown in FIG. 8, the gate passing determination unit 35 sets four detection target areas divided into four quadrants with respect to the image in advance. Then, when the detection mark 60 is detected in all the detection target areas of “first detection target area 35b” as a first quadrant, “second detection target area 35c” as a second quadrant, “third detection target area 35d” as a third quadrant, and “fourth detection target area 35e” as a fourth quadrant in the predetermined image, it is determined that the second condition is satisfied.

In this Example 1 of FIG. 8, it can be seen that the detection mark 60 is detected in an area different from the non-detection target area 35a in a predetermined image (frame image) and the detection mark 60 is detected in all the detection target areas of a first detection target area 35b, a second detection target area 35c, a third detection target area 35d, and a fourth detection target area 35e.

Thereafter, when all the detection marks 60 are no longer detected in an image (subsequent frame image) after the predetermined image, the gate passing determination unit 35 determines that the unmanned mobile body 1 has passed through the passing gate 50 in which the detection mark 60 is provided.

In addition, in this Example 2 of FIG. 8, it can be seen that the detection mark 60 is detected in an area different from the non-detection target area 35a in a predetermined image (frame image) but the detection mark 60 is detected only in the detection target areas of the first detection target area 35b and the second detection target area 35c.

In this case, the gate passing determination unit 35 does not determine that the unmanned mobile body 1 has passed through the passing gate 50 in which the detection mark 60 is provided.

The elapsed time calculation unit 36 calculates the elapsed time (lap time), which is required for a predetermined unmanned mobile body 1 to pass through a predetermined passing gate 50 from a predetermined start position, from the determination result of the gate passing determination unit 35.

More specifically, the elapsed time calculation unit 36 calculates the elapsed time (lap time) and generates “lap time data” indicating the elapsed time.

As described above, the “lap time data” includes the information such as the elapsed time (section lap time) required for each unmanned mobile body 1 to pass through a predetermined passing gate 50 from a predetermined start position, the elapsed time required from the start position to one lap of the course (lap time of the first lap, second lap, third lap), or the elapsed time required from the start position to the goal position (total lap time required to finish three laps of the course).

The current position calculation unit 37 calculates the current position of the unmanned mobile body 1 in a predetermined space from the above determination result of the gate passing determination unit 35.

More specifically, the current position calculation unit 37 calculates the current position and generates “current position data” indicating the current position.

As described above, the “current position data” includes position information indicating at which passing gate 50 each unmanned mobile body 1 is located on the course of the unmanned mobile race.

In addition, when the current position calculation unit 37 calculates the current position of the predetermined unmanned mobile body 1, information of the lap time of the unmanned mobile body 1 during the race, the lap time of the past race of the operator operating the unmanned mobile body 1, and the like is also referred to, so that the current position of the unmanned mobile body 1 can be calculated more accurately.

By calculating the current position of the unmanned mobile body 1 in this manner, the current position display icon 49a on the course map 49 can be displayed while being accurately moved on the display screen shown in FIG. 7.

<Image Processing Method>

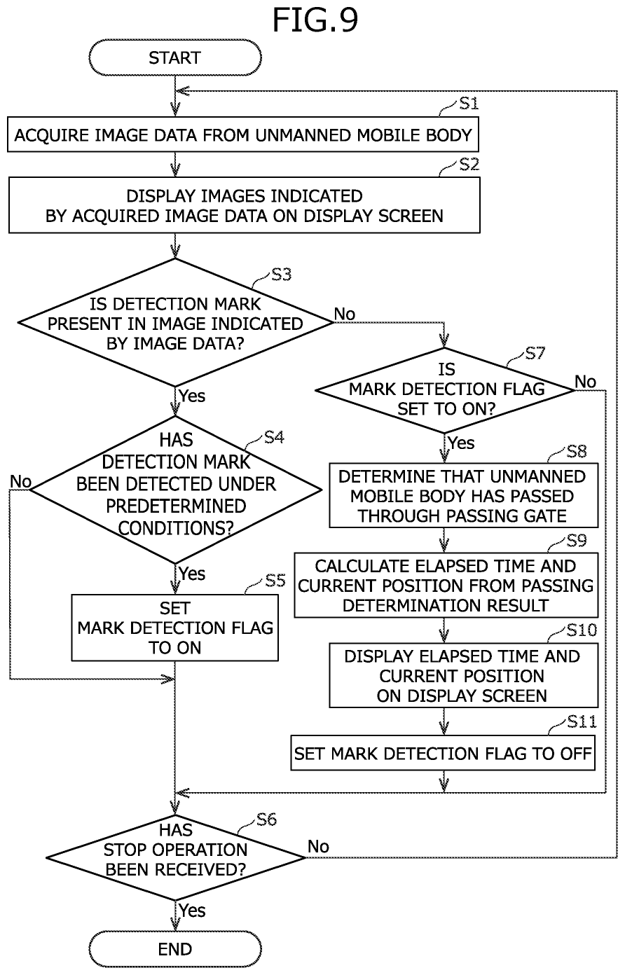

Next, processing of an image processing program (image processing method) executed by the image processing device 30 will be described with reference to FIG. 9.

The program according to the present embodiment is a utility program in which various programs are integrated in order to realize the above-described image data acquisition unit 32, screen display unit 33, mark detection unit 34, gate passing determination unit 35, elapsed time calculation unit 36, and current position calculation unit 37 as functional components of the image processing device 30 including the storage unit 31, and the CPU of the image processing device 30 executes this image processing program.

In addition, the above program is executed by receiving an operation of starting image processing from the user.

In the “image process flow” shown in FIG. 9, first, the image data acquisition unit 32 starts from step S1 of acquiring “image data” from each unmanned mobile body 1.

In addition, the acquired image data is classified for each unmanned mobile body 1 and stored in the storage unit 31.

Then, in step S2, the screen display unit 33 (image display unit 33a) simultaneously displays images (real-time images) indicated by the “image data” acquired from the respective unmanned mobile bodies 1 on the display 40, as shown in FIG. 7.

Then, in step S3, the mark detection unit 34 detects the presence of the detection mark 60 as a detection target in the image indicated by the acquired “image data”.

If the mark detection unit 34 detects the presence of the detection mark 60 in the image (step S3: Yes), the process proceeds to step S4. On the other hand, if the detection mark 60 is not present in the image (step S3: No), the process proceeds to step S7.

Then, in step S4, the gate passing determination unit 35 determines whether or not the detection mark 60 has been detected under predetermined conditions in the image indicated by the acquired “image data”, as shown in FIG. 8.

More specifically, as the first condition, the gate passing determination unit 35 sets the non-detection target area 35a in advance in a central portion of the image, and determines whether or not the detection mark 60 has been detected in an area different from the non-detection target area 35a in the predetermined image.

In addition, as the second condition, the gate passing determination unit 35 sets the four detection target areas 35b to 35e divided into four quadrants with respect to the image in advance. Then, it is determined whether or not the detection mark 60 has been detected in all the detection target areas 35b to 35e in the predetermined image.

If the gate passing determination unit 35 determines that the detection mark 60 has been detected under predetermined conditions in the image (step S4: Yes), the process proceeds to step S5 to set the mark detection flag to ON. Then, the process proceeds to step S6.

On the other hand, if it is determined that the detection mark 60 has not been detected under predetermined conditions in the image (step S4: No), the process proceeds to step S6.

Then, in step S6, it is determined whether or not the image processing device 30 has received an operation of stopping the image processing from the user.

If the image processing device 30 has not received the operation of stopping the image processing from the user (step S6: No), the process returns to step S1. In addition, if the image processing device 30 has received the operation of stopping the image processing from the user (step S6: Yes), the process of FIG. 9 ends.

Then, after returning to step S1 from step S6, if the detection mark 60 is not present in an image indicated by the next acquired “image data” (when none of the detection marks 60 are present) (step S3: No), the process proceeds to step S7 in which the image processing device 30 determines whether or not the mark detection flag is set to ON.

If the mark detection flag is set to ON (step S7: Yes), the process proceeds to step S8, and if the mark detection flag is not set to ON (step S7: No), the process proceeds to step S6.

Then, in step S8, the gate passing determination unit 35 determines that the detection mark 60 is detected under predetermined conditions in an image indicated by the acquired “image data” and the detection mark 60 is no longer detected in an image after the image, and determines that the predetermined unmanned mobile body 1 has passed through the passing gate 50 in which the detected detection mark 60 is provided.

Then, in step S9, the elapsed time calculation unit 36 calculates the elapsed time (lap time), which is required for the predetermined unmanned mobile body 1 to pass through a predetermined passing gate 50 from a predetermined start position, from the determination result of the gate passing determination unit 35. That is, “lap time data” is generated.

In addition, the current position calculation unit 37 calculates the current position of the unmanned mobile body 1 in a predetermined space from the above determination result of the gate passing determination unit 35. That is, “current position data” is generated.

Then, in step S10, the elapsed time display unit 33b displays “content relevant to the elapsed time (lap time) of each unmanned mobile body 1” calculated by the elapsed time calculation unit 36 on the display 40 as the above-described content based on the determination result.

In addition, the current position display unit 33c can display “content relevant to the current position of each unmanned mobile body 1” calculated by the current position calculation unit 37 on the display 40 as the above-described content based on the determination result.

Specifically, this is as shown in the display screen of FIG. 7.

Then, in step S11, the image processing device 30 sets the mark detection flag to OFF, and then proceeds to step S6.

When the operation of stopping the image processing is finally received from the user in the process of steps S1 to S11 (step S6: Yes), the process of FIG. 9 ends.

According to the above-described process flow of the image processing program, it is possible to accurately detect the position of the unmanned mobile body 1 and accurately measure the timing of passing through a predetermined position.

In addition, in order to enhance entertainment in managing the unmanned mobile race, it is possible to create a realistic production effect.

<Movement Start Determination>

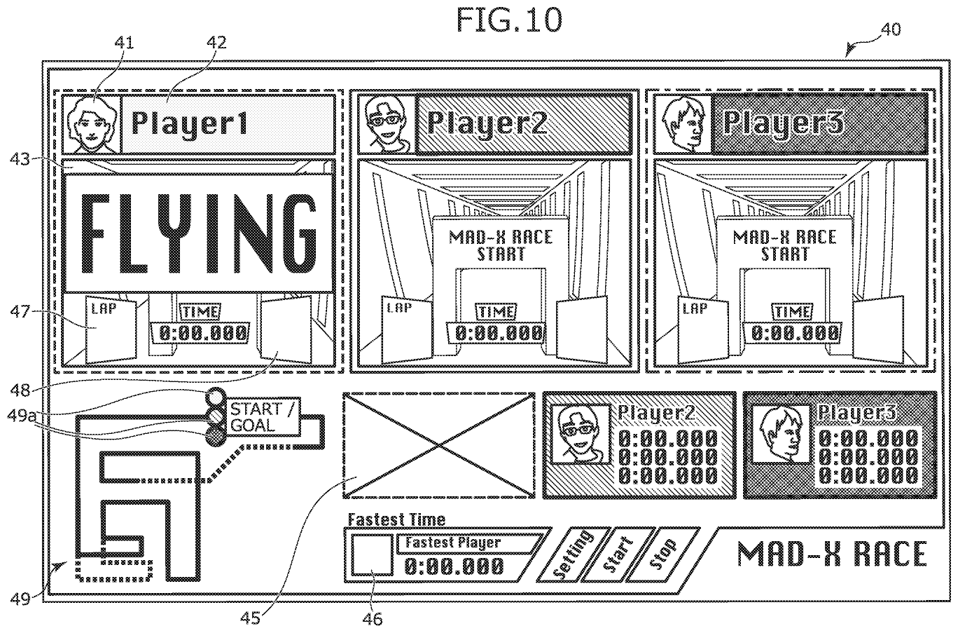

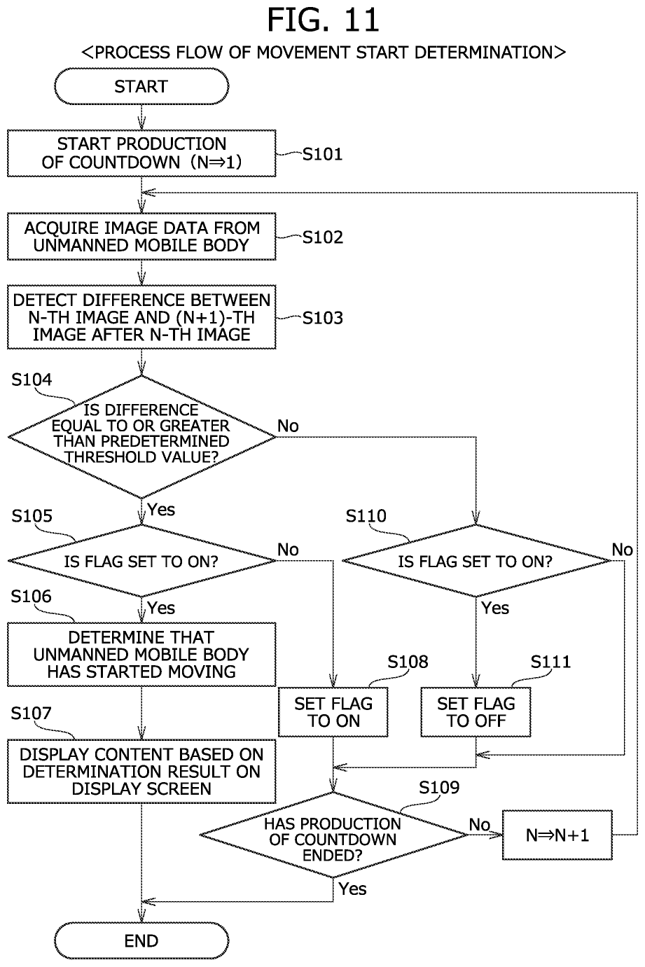

Next, the function of the movement start determination unit 38 executed by the image processing device 30 will be described with reference to FIGS. 10 and 11.

The movement start determination unit 38 starts movement start determination for the unmanned mobile body 1 with the timing immediately before the unmanned mobile body 1 starts moving as a trigger start condition.

When a difference between a first image indicated by “image data” acquired from the unmanned mobile body 1 and a second image after the first image is detected and it is determined that the difference is equal to or greater than a predetermined threshold value (first condition) and a difference between the second image and a third image after the second image is detected and it is determined that the difference is equal to or greater than a predetermined threshold value (second condition), the movement start determination unit 38 determines that the unmanned mobile body 1 has started moving.

Specifically, the movement start determination unit 38 determines false start (flying start) of each unmanned mobile body 1 in the unmanned mobile race.

With the above configuration, the image processing device 30 can automatically detect the false start and can accurately detect the false start, even though the false start is determined, for example, by visual check in the conventional unmanned mobile race.

More specifically, first, the movement start determination unit 38 executes binarization processing by applying a preset binarization threshold value to the acquired first image, thereby acquiring “first processed image data” indicating a first processed image. The binarization processing is also executed on the next acquired second image to acquire “second processed image data” indicating a second processed image.

Then, a difference between the first processed image and the second processed image is detected, and when the difference becomes equal to or greater than a “predetermined threshold value” in the entire image, it is determined that the first condition is satisfied.

In addition, regarding the “predetermined threshold value”, for example, when the above difference is “80%” or more, preferably “90%” or more in the entire image, it may be determined that the first condition is satisfied.

As the second condition, the movement start determination unit 38 executes binarization processing on a third image acquired next, thereby acquiring “third processed image data” indicating the third processed image.

Then, a difference between the second processed image and the third processed image is detected, and when the difference becomes equal to or greater than a “predetermined threshold value” in the entire image, it is determined that the second condition is satisfied.

When the first condition and the second condition are satisfied, the movement start determination unit 38 determines that the unmanned mobile body 1 has started moving. That is, it is determined that the unmanned mobile body 1 has started falsely.

The movement start determination unit 38 ends the movement start determination for the unmanned mobile body 1 with the timing at which the unmanned mobile race starts as a trigger end condition.

In the above configuration, when the movement start determination unit 38 determines that the predetermined unmanned mobile body 1 has started falsely, the screen display unit 33 displays the content based on the determination result on the display 40.

In this example of FIG. 10 as a display screen on the display 40, the content “FLYING” for notifying of the false start is popped up on the real-time image 43 of the operator “Player 1”. In addition, the lap time 45 of the operator “Player 1” is not displayed.

In this manner, it is possible to inform spectators of real-time information immediately before and after the start of the unmanned mobile race, and it is possible to produce the realistic content of the unmanned mobile race.

In addition, in the above configuration, the movement start determination unit 38 starts processing with the timing immediately before the unmanned mobile body 1 starts moving as a “trigger start condition” and, for example, the start of the production of countdown immediately before the start of the unmanned mobile race may be set as the trigger start condition.

Specifically, the timing at which the screen display unit 33 displays the production content of the countdown on the display 40 in response to the input of the user operation may be set as the trigger start condition.

Then, as the “trigger end condition” of the movement start determination unit 38, it is preferable that the screen display unit 33 ends the production content of the countdown and the start production of the unmanned mobile race is the condition.

In this manner, the image processing device 30 can accurately detect the false start, and it is possible to prevent the image processing device 30 from erroneously detecting the false start during the preparation of the race or after the start of the race.

<Movement Start Determination Method>

Next, processing of a movement start determination program (movement start determination method) executed by the image processing device 30 will be described with reference to FIG. 11.

In the “movement start determination process flow” shown in FIG. 11, first, the image display unit 33a starts from step S101 in which the production content of countdown (not shown) is displayed in response to the input of the user operation.

The start of the production of the countdown becomes the trigger start condition, so that the movement start determination unit 38 starts movement start determination for each unmanned mobile body 1.

Then, in step S102, the image data acquisition unit 32 acquires “image data” from each unmanned mobile body 1.

Then, in step S103, the movement start determination unit 38 detects a difference between an N-th image indicated by the “image data” acquired from the unmanned mobile body 1 and an (N+1)-th image after the N-th image.

If the movement start determination unit 38 determines that the difference is equal to or greater than a predetermined threshold value (step S104: Yes), the process proceeds to step S105. On the other hand, if the difference is less than the predetermined threshold value (step S104: No), the process proceeds to step S110.

Then, in step S105, the movement start determination unit 38 determines whether or not the flag is set to ON.

If the flag is set to ON (step S105: Yes), the movement start determination unit 38 determines that a predetermined unmanned mobile body 1 has started moving (false start) (step S106).

Then, as shown in FIG. 10, the screen display unit 33 displays the content based on the determination result on the display 40 (step S107), and ends the process of FIG. 11.

If the flag is not set to ON (step S105: No), the process proceeds to step S108 to set the flag to ON, and then proceeds to step S109.

In step S109, it is determined whether or not the production content of countdown has ended, and if the production content has ended and the unmanned mobile race has started (step S109: Yes), the process of FIG. 11 ends.

On the other hand, if the production content of the countdown has not ended (step S109: No), the process returns to step S102.

If the difference is less than a predetermined threshold value in step S104, the process proceeds to step S110 in which the movement start determination unit 38 determines whether or not the flag is set to ON.

If the flag is set to ON (step S110: Yes), the flag set to ON is set to OFF (step S111), and then the process proceeds to step S109.

If the flag is not set to ON (step S110: No), the process proceeds to step S109.

In step S109, if the production content of the countdown has ended (step S109: Yes), the process of FIG. 11 ends, and if the production content has not ended (step S109: No), the process return to step S102.

According to the process flow of the movement start determination program, the image processing device 30 can accurately determine the false start of a predetermined unmanned mobile body 1 in the unmanned mobile race.

### OTHER EMBODIMENTS

In the embodiment described above, as shown in FIG. 1, the unmanned mobile body 1 is a small unmanned aerial vehicle (drone). However, the unmanned mobile body 1 is not particularly limited to the drone, and changes to any unmanned mobile body in which an imaging apparatus is mounted can be appropriately made.

For example, a radio-controlled car traveling on the ground, an unmanned helicopter flying in the air, and a ship or a yacht moving on the water may be used. In addition, the present invention is not particularly limited to toys, and can be widely applied to commercial unmanned aerial vehicles, unmanned automobiles, and the like.

In the embodiment described above, as shown in FIG. 1, the image processing system S is a system for managing the unmanned mobile race. However, the image processing system S is not particularly limited to the system for the unmanned mobile race, and can be widely applied to various businesses as an image processing system and an image processing device using an unmanned mobile body (drone).

In the embodiment described above, as shown in FIG. 1, a plurality of unmanned mobile bodies 1 are used in the image processing system S, but the present invention is not particularly limited thereto. For example, the number of unmanned mobile bodies may be one if the image processing system S is used as a commercial system.

In the embodiment described above, as shown in FIGS. 1 and 4, the detection mark 60 is a two-dimensional barcode, but any mark that can be detected in an image can be widely applied without being particularly limited thereto. Preferably, the detection mark is a mark capable of storing identification information.

In the embodiment described above, as shown in FIGS. 1 and 4, the detection mark 60 is arranged so as to surround the passing area 53 of the passing gate 50, but the arrangement pattern of the detection mark 60 can be appropriately changed without being particularly limited thereto.

For example, the detection marks 60 may be arranged in a horizontal row in the upper portions of the passing gates 50 and 150, and the unmanned mobile body 1 may be made to pass through the passing area immediately below the detection marks 60.

In addition, the detection mark 60 is attached to the front surface side of the passing gate 50, which is located on the start side in the traveling direction of the course. However, the attachment position of the detection mark 60 is not particularly limited, and the detection mark 60 may be attached to the rear surface side of the passing gate 50 depending on the course arrangement of the unmanned mobile race.

In addition, the shapes and arrangements of the passing gates 50 and 150 and the passing areas 53 and 153 can be appropriately changed.

In the embodiment described above, as shown in FIG. 7, the screen display unit 33 displays, on the display 40, “content based on a determination result” when the gate passing determination unit 35 determines that each unmanned mobile body 1 has passed a predetermined passing gate 50.

At this time, the “content based on a determination result” is not particularly limited to the information regarding the elapsed time and the current position of each unmanned mobile body 1, but may broadly include other information obtained from the above determination result, that is, other real-time information during the unmanned mobile race.

For example, when the unmanned mobile body 1 successfully flies over the central portion of the passing area 53 of the predetermined passing gate 50 or when the unmanned mobile body 1 goes off the course and passes through the passing gate 50 other than the passing gate 50 through which the unmanned mobile body 1 should originally pass, it is also possible to display a predetermined production content on the display 40.

In addition, when two unmanned mobile bodies 1 fly close to each other in the unmanned mobile race, it is possible to create a more realistic production effect by partially (or totally) switching the display screen on the display 40 and displaying the image captured by the unmanned mobile body 1 on the rear side.

In the embodiment described above, as shown in FIG. 8, the gate passing determination unit 35 determines that the unmanned mobile body 1 has passed through the passing gate 50 when the detection mark 60 is detected under predetermined conditions in an image indicated by the acquired “image data” and none of the detection marks 60 are detected in an image after the image. However, this can be changed without being particularly limited thereto.

For example, the gate passing determination unit 35 may determine that the unmanned mobile body 1 has passed through the passing gate 50 when the detection mark 60 is simply detected in the image. Alternatively, the gate passing determination unit 35 may determine that the unmanned mobile body 1 has passed through the passing gate 50 when the detection mark 60 is simply detected and none of the detection marks are detected in the subsequent image.

Alternatively, the gate passing determination unit 35 may determine that the unmanned mobile body 1 has passed through the passing gate 50 when the detection mark 60 is detected in at least two or more (three or more) detection target areas 35b to 35e in the image and the detection mark 60 is no longer detected in at least two or more (three or more) detection target areas 35b to 35e in the subsequent image.

Alternatively, the gate passing determination unit 35 may detect the detection mark 60 in the image without particularly setting the non-detection target area 35a.

In the embodiment described above, as shown in FIG. 10, when the movement start determination unit 38 determines that the predetermined unmanned mobile body 1 has started moving (false start), the screen display unit 33 displays the content based on the determination result on the display 40. At this time, the screen display unit 33 may display the content based on the determination result not only on the display 40 but also on the head-mounted display 20.

In this manner, it is possible to notify not only the spectators watching the unmanned mobile race but also the actual operator of the real-time information of the false start.

In the embodiment described above, as shown in FIG. 11, the movement start determination unit 38 determines that the unmanned mobile body 1 has started moving when a difference between the first image and the second image acquired from the unmanned mobile body 1 is detected and it is determined that the difference is equal to or greater than a predetermined threshold value (first condition) and a difference between the second image and the third image is detected and it is determined that the difference is equal to or greater than a predetermined threshold value (second condition), but this can be changed without being particularly limited thereto.

For example, the movement start determination unit 38 may determine that the unmanned mobile body 1 has started moving when only the first condition is satisfied.

In addition, when the first condition and the second condition are continuously satisfied, the movement start determination unit 38 can determine that the unmanned mobile body 1 has started moving to improve the determination accuracy. For example, a state in which the unmanned mobile body 1 temporarily moves and then stops can be handled as an exception.

In the embodiment described above, the image processing program is stored in a recording medium that can be read by the image processing device 30, and the processing is executed by the image processing device 30 reading and executing the program. Here, the recording medium that can be read by the image processing device 30 refers to a magnetic disk, a magneto-optical disk, a CD-ROM, a DVD-ROM, a semiconductor memory, and the like.

In addition, the image processing program may be distributed to a user terminal (not shown) through a communication line, and the user terminal itself that receives the distribution may function as an image processing device to execute the program.

In the embodiment described above, the image processing system, the image processing method, and the image processing device using an unmanned mobile body according to the present invention have been mainly described.

However, the embodiment described above is merely an example for facilitating the understanding of the present invention, and does not limit the present invention. It is needless to say that the present invention can be modified and improved without departing from the spirit of the present invention and the present invention includes equivalents thereof.

### REFERENCE SIGNS LIST

S: image processing system
1: unmanned mobile body (unmanned aerial vehicle)
   1a: imaging apparatus
   1b: transmission and reception antenna
   1c: mobile unit
   1d: driving unit
   1e: processor
   1f: battery
2: storage unit
3: operation data receiving unit
4: image data transmission unit
10: operation terminal
20: head-mounted display
30: image processing device
31: storage unit
32: image data acquisition unit
33: screen display unit
   33a: image display unit
   33b: elapsed time display unit
   33c: current position display unit
34: mark detection unit
35: gate passing determination unit
   35a: non-detection target area
   35b: first detection target area
   35c: second detection target area
   35d: third detection target area
   35e: fourth detection target area
36: elapsed time calculation unit
37: current position calculation unit
38: movement start determination unit
40: display
41: operator image
42: operator name
43: real-time image
44: total race time
45: lap time
46: fastest lap time
47: number of laps
48: current ranking
49: course map
   49a: current position display icon
50, 150: passing gate
51, 151: gate leg
52, 152: gate frame body
53, 153: passing area
60: detection mark

1. An image processing system using an unmanned mobile body, comprising:
an unmanned mobile body in which an imaging apparatus is mounted and which moves while capturing an external image; and
an image processing device that is connected to the unmanned mobile body by wireless communication and processes an image captured by the imaging apparatus,
wherein the image processing device includes:
an image data acquisition unit that acquires image data indicating an external image captured by the imaging apparatus;
a screen display unit that displays the image indicated by the acquired image data on a display screen;
a mark detection unit that detects presence of a detection mark as a detection target in the image indicated by the acquired image data; and
a gate passing determination unit that determines that the unmanned mobile body has passed through a passing gate on which the detected detection mark is provided when the detection mark is detected under predetermined conditions in the image, and
the screen display unit displays, on the display screen, the image and a content based on a determination result when it is determined that the unmanned mobile body has passed through the passing gate.

2. The image processing system using an unmanned mobile body according to claim 1,
wherein the unmanned mobile body is a small unmanned aerial vehicle, and moves on a predetermined course in a predetermined space, and
the screen display unit simultaneously displays, on the display screen, images captured by the imaging apparatuses respectively mounted in a plurality of the unmanned mobile bodies.

3. The image processing system using an unmanned mobile body according to claim 1, further comprising:
the detection mark provided on the passing gate installed in a predetermined space,
wherein a plurality of the detection marks are attached to the passing gate so as to surround a passing area in the passing gate.

4. The image processing system using an unmanned mobile body according to claim 1, further comprising:
the detection mark provided on the passing gate installed in a predetermined space,
wherein the detection mark is a two-dimensional barcode, and stores identification data for identifying a corresponding passing gate among the plurality of passing gates installed in the predetermined space.

5. The image processing system using an unmanned mobile body according to claim 1,
wherein, after an area smaller than a passing area in the passing gate in a central portion of the image is set as a non-detection target area, when the detection mark is detected in an area different from the non-detection target area in a predetermined image and the detection mark is no longer detected in an image after the predetermined image, the gate passing determination unit determines that the unmanned mobile body has passed.

6. The image processing system using an unmanned mobile body according to claim 1,
wherein, after setting four detection target areas divided into four quadrants with respect to the image, when the detection mark is detected in all detection target areas of a first detection target area as a first quadrant, a second detection target area as a second quadrant, a third detection target area as a third quadrant, and a fourth detection target area as a fourth quadrant in a predetermined image and the detection mark is no longer detected in an image after the predetermined image, the gate passing determination unit determines that the unmanned mobile body has passed.

7. The image processing system using an unmanned mobile body according to claim 1,
wherein the image processing device includes an elapsed time calculation unit that calculates, from the determination result of the gate passing determination unit, an elapsed time required for the unmanned mobile body to pass through a predetermined passing gate from a predetermined start position, and
the screen display unit displays, on the display screen, the image and a content relevant to the elapsed time calculated by the elapsed time calculation unit.

8. The image processing system using an unmanned mobile body according to claim 1,
wherein the image processing device includes a current position calculation unit that calculates, from the determination result of the gate passing determination unit, a current position of the unmanned mobile body in the predetermined space, and
the screen display unit displays, on the display screen, the image and a content relevant to the current position calculated by the current position calculation unit.

9. An image processing method using an unmanned mobile body in which a computer connected to an unmanned mobile body, in which an imaging apparatus is mounted and which moves while capturing an external image, by wireless communication processes an image captured by the imaging apparatus, the method causing the computer to execute:
an image data acquisition step for acquiring image data indicating an external image captured by the imaging apparatus;
a first screen display step for displaying the image indicated by the acquired image data on a display screen;
a mark detection step for detecting presence of a detection mark as a detection target in the image indicated by the acquired image data;
a gate passing determination step for determining that the unmanned mobile body has passed through a passing gate on which the detected detection mark is provided when the detection mark is detected under predetermined conditions in the image; and
a second screen display step for displaying, on the display screen, the image and a content based on a determination result when it is determined that the unmanned mobile body has passed through the passing gate.

10. An image processing device using an unmanned mobile body that is connected to the unmanned mobile body, in which an imaging apparatus is mounted and which moves while capturing an external image, by wireless communication and processes an image captured by the imaging apparatus, the device comprising:
an image data acquisition unit that acquires image data indicating an external image captured by the imaging apparatus;
a mark detection unit that detects presence of a detection mark as a detection target in the image indicated by the acquired image data; and
a gate passing determination unit that determines that the unmanned mobile body has passed through a passing gate on which the detected detection mark is provided when the detection mark is detected under predetermined conditions in the image.
